(19) United States
(12) Patent Application Publication
(10) Pub. No.: US 2024/0409390 A1
(43) Pub. Date: Dec. 12, 2024

(54) CHEMICAL SUPPLIER

(71) Applicant: ATIK Co., Ltd., Seongnam-si (KR)

(72) Inventors: Young Ho HONG, Seoul (KR); Yong Jin LEE, Hwaseong-si (KR)

(21) Appl. No.: 18/645,406

(22) Filed: Apr. 25, 2024

(30) Foreign Application Priority Data
Jun. 9, 2023 (KR) 10-2023-0074192

(51) Int. Cl. B67D 3/00

(52) U.S. Cl. CPC B67D 3/0029; B67D 3/0061; B67D 3/0083; B67D 2210/00097

(57) ABSTRACT

A chemical supplier is proposed. The chemical supplier includes a bottle storing a fluid to be supplied therein and including a discharge port formed at a lower portion thereof, a reservoir including an inlet formed at an upper portion thereof, the inlet being fluidically connected to the discharge port, to receive the fluid to be supplied, which including an outlet formed at one portion thereof to supply the fluid to be supplied outward, a joint assembly of a mutual cognition structure, which is provided between the bottle and the reservoir to control physical coupling between the bottle and the reservoir, and a guide casing storing the bottle in a removable manner and supporting the bottle and the reservoir connected to each other by the joint assembly in a connected state. The chemical supplier has convenience of chemical replacement work, and can prevent errors in mounting and replacing a chemical.

### CROSS REFERENCE TO RELATED APPLICATIONS

The present application claims priority to Korean Patent Application No. 10-2023-0074192, filed Jun. 9, 2023, the entire contents of which is incorporated herein for all purposes by this reference.

### BACKGROUND

### 1. Technical Field

The present disclosure relates to a chemical supplier and, more particularly, a chemical supplier to supply a fluid.

### 2. Description of the Related Art

In general, all companies that use hazardous chemical substances, including companies that manufacture semiconductors, semiconductor devices, LCDs, and OLEDs, pharmaceutical companies, and paint companies use various types of chemicals. Specifically, a semiconductor device manufacturing process includes many processes, and various types of chemical substances are used in each process. Furthermore, these chemical substances must have very precise conditions, such as precise concentrations, mixing ratios, temperature, and acidity, etc.

For example, a titrating device for measuring the concentration of a chemical substance used in a semiconductor device includes a titrating device reagent reservoir. The titrating device continuously prepares several reagents and supplies a reagent necessary according to a target to be titrated. Normally, titration work requires a very precise supply of a reagent, and errors in the amount or type of a reagent cause serious problems. Therefore, it is important to supply a correct type of reagent in the correct amount.

In order to always satisfy the titration conditions for various types of chemical substances and to efficiently supply substances to necessary processes or devices under the correct conditions and time, a device is needed to prepare a number of corresponding chemicals inside the process equipment or apparatus and to provide each chemical whenever needed. For example, a chemical concentration monitoring device related to a specific chemical tank monitors the concentration of the corresponding chemical through a sensor, and at the same time, may supply several types of chemicals for adjusting a condition of a chemical as needed, and may supply test chemical for titration of a chemical to a detecting device.

However, a chemical supplier where multiple chemicals are loaded, does not require that all chemicals must be supplied, used, replenished, or replaced at the same time. For example, the usage may vary depending on each chemical, and accordingly, the chemical supplier must check chemical types that are easy to be frequently in short supply and prepare to supply them in a timely manner. Unless the usage is very large, a method of preparing a chemical container of a certain capacity and replacing the chemical container to supplement the shortage of chemical is often used.

Methods for safely supplying these chemicals are also diversified. To this end, a conventional chemical supply system has a structure of supplying a chemical from a plurality of chemical containers. A discharge tube is connected to the chemical container through a cap opening and closing an opening of each chemical container, and with a discharge pump connected to the discharge tube the chemical inside the chemical container is sucked by operation of the discharge pump and is supplied to a place where the chemical is used, through the discharge tube.

However, in a chemical supply system having this form, when a chemical is used up in one container, a container filled with the chemical is prepared and is replaced with an empty container empty at the correspond location to be used.

To this end, work of opening a cap of a new container filled with a chemical, and opening a cap of an exhausted container at the corresponding location, and removing the exhausted container from the corresponding location, and placing the new container into the corresponding location, and coupling a cap with the discharge tube to the new container is usually performed.

However, the conventional chemical supply system may have a problem of replacing and exchanging a container storing a different type of chemical at an inappropriate location because of a confusion about a type of chemical that needs to be replaced due to the same shape and size of containers.

In order to prevent this problem, although a type of chemical is indicated on a container, there is always a possibility of error due to the carelessness of an operator.

Specifically, in semiconductor device manufacturing processes or titrating device that require precise processes, this chemical confusion may lead to fatal results in the processes or the chemical supplier.

Therefore, the operator must focus the operator's attention to prevent the incorrect replacement, but since mistakes can always occur in human work, a multiple chemical suppliers that can prevent such incorrect replacement problem is required.

Meanwhile, the conventional chemical supply system is installed such that an end of the discharge tube inserted into the container extends to a bottom surface of the container, but a small gap occurs therebetween and it is difficult to use all the chemicals on the bottom of the container, and the remaining amount of the chemical occurs repeatedly when replacing the container. However, when the remaining amount of chemical does not exist, the chemical supply system becomes unable to supply the chemical and replacement and process interruption usually follow.

Furthermore, when the container is replaced, the discharge tube is separated from the container along with the cap so the chemical cannot be supplied, and when continuous process progress is required, many problems may occur as a result of process interruption due to replenishment or replacement of the chemical. In order to prevent the problems, there is a problem of making the connection of supply lines complicated and increasing facility costs.

Moreover, when the work is performed, sufficient work space may not be secured due to the surrounding environment, and according to a specific shape of replacement configuration, a chemical flows out and contaminates the surroundings, or substances harmful to a worker's health may adhere to or splash onto the worker, harming the working environment and increasing the possibility of problems harming the worker's health.

In other words, the processes of separating the cap from the container and connecting a coupler connected with a fluid line are performed by the worker manually, so there is a high risk that the worker will be exposed to hazardous chemicals during the work processes, leading to safety accidents.

Furthermore, in the process of replacing the exhausted container and the new container, the discharge tube provided in the cap is exposed outward from the container and there is the possibility that a chemical filled in or adhered to the discharge tube may fall or splash to the surroundings.

Accordingly, not only may the chemical in the discharge tube leak, but air may be introduced into the discharge tube, and the air continues to remain even after container replacement to generate bubbles in a chemical supply line, and the chemical is supplied with the bubbles present in the process, causing problems in the process. In other words, problems of data stability may be caused.

### SUMMARY

Accordingly, the present invention has been made keeping in mind the above problems occurring in the related art, and the present invention is intended to propose a chemical supplier which can have convenience of chemical replacement work.

Another objective of the present disclosure is to provide a chemical supplier which can prevent or reduce errors when a chemical container is mounted and replaced.

Yet another objective of the present disclosure is provide to a chemical supplier which can efficiently perform mounting and replacement work of a chemical, prevent leakage of content during replacement, and minimize generation of bubbles.

Still another objective of the present disclosure is to provide a chemical supplier which can replace a chemical supply container without interruption of a chemical supply.

In order to achieve the above-described objectives, according to the present disclosure, there is provided a chemical supplier, the chemical supplier a chemical supplier including: a bottle storing a fluid to be supplied therein and including a discharge port formed at a lower portion thereof; a reservoir including an inlet formed at an upper portion thereof, the inlet being fluidically connected to the discharge port, to receive the fluid to be supplied, which including an outlet formed at one portion thereof to supply the fluid to be supplied outward; a joint assembly of a mutual cognition structure, which is provided between the bottle and the reservoir to control physical coupling between the bottle and the reservoir; and a guide casing storing the bottle in a removable manner and supporting the bottle and the reservoir connected to each other by the joint assembly in a connected state.

The guide casing may include: a casing main body unit in which the bottle and the reservoir are provided; a first mounting unit formed at an upper portion of the casing main body unit to be open to divide an installation space of the bottle; and a second mounting unit formed at a second portion of the casing main body unit to be open and disposed to be spaced apart from a lower portion of the first mounting unit to divide an installation space of the reservoir. The guide casing may maintain the reservoir and the bottle stored in the respective mounting units at a constant interval.

The casing main body unit may include: a base plate provided at a bottom; and a plurality of vertical plates provided upright to face each other at opposite portions of the base plate and restricting lateral movements of the bottle and the reservoir.

The casing main body unit may include a support plate disposed at a first side of the vertical plates to cross between the vertical plates to support a lower surface of the bottle.

The casing main body unit may include auxiliary support pieces formed by protruding on a second side of the vertical plates with intervals from the support plate and supporting the lower surface of the bottle.

At this point, the support plate and the auxiliary support pieces may have upper surfaces that are inclined downward to face each other. In other words, the support plate and the auxiliary support pieces may be disposed to be inclined downward toward the discharge port formed at the lower portion of the bottle.

The bottle may include a protruding block protruding on at least one surface thereof, and to correspond the protruding block, the vertical plates may include inserting slots formed to be open upward such that the protruding block is insertable.

The vertical plates may have paths of a predetermined curvature at upper portions thereof to provide sliding guide surfaces along which the protruding block provided on the bottle is movable to the position of the inserting slots while being seated on the upper portions.

The casing main body unit may include stoppers provided by protruding on inner surfaces of the vertical plates to prevent the reservoir inserted from the second side from being removed toward the first side.

According to the embodiment, the casing main body unit may include first pushing pieces provided by protruding on positions of the inner surfaces of the vertical plates while being spaced apart from the stoppers to support an upper surface of the reservoir.

At this point, the casing main body unit may include second pushing pieces formed by extending horizontally from the stoppers to support the upper surface of the reservoir. The second pushing pieces may stably support the reservoir while being disposed to be spaced apart from the first pushing pieces.

Meanwhile, The joint assembly may include: a first cognition unit formed at the bottle and including a coupling groove fixed at a position selected according to a type of the fluid to be supplied; and a second cognition unit formed at the reservoir and including a coupling key of which a position is changeable to correspond to the position of the coupling groove.

As described above, the chemical supplier of the present disclosure may provide the structure which limits or allows the physical coupling by the key coupling structure performing the mutual cognition function, so that mis-injection of a fluid due to accidental coupling can be prevented in advance.

Furthermore, the chemical supplier of the present disclosure has the valve structure to allow coupling between the containers to be easily performed, and prevent a chemical from being arbitrarily discharged, so that a problem of a chemical leakage during replacement can be minimized.

Furthermore, the chemical supplier of the present disclosure has the docking structure of the up-down method so that mounting and separation of the containers can be simply performed. Accordingly, the chemical supplier of the present disclosure is simplified in replacement work, so that the convenience of the replacement work can be provided.

In addition, according to the present disclosure, as the upper container and the lower container are connected to each other and multiple chemicals are continuously supplied during replenishment or replacement, thus preventing a problem such as a process interruption, and the containers are held at the upper portion and the lower portion of the supplier to allow entire reuse of the remaining amount during replacement, so there is an advantage in reducing production costs.

Moreover, the chemical supplier of the present disclosure has a structure which can prevent bubbles from being generated during replacement work or filling work, thus improving data stability.

### BRIEF DESCRIPTION OF THE DRAWINGS

FIG. 1 is a perspective view schematically showing a chemical supplier according to an embodiment of the present disclosure.

FIG. 2 is a sectional view of FIG. 1.

FIG. 3 is a perspective view schematically showing another example of the chemical supplier according to the embodiment of the present disclosure.

FIG. 4 is an exploded-perspective view showing a part of components of FIG. 3.

FIGS. 5 and 6 are enlarged sectional views from FIG. 2, the views showing a connecting part of a bottle and a reservoir of the chemical supplier according to the embodiment of the present disclosure.

FIGS. 7 and 8 are partial-exploded perspective views each enlarged from FIG. 4, the views showing a joint assembly of the chemical supplier according to the embodiment of the present disclosure.

FIG. 9 is a perspective view schematically showing a guide casing of the chemical supplier according to the embodiment of the present disclosure.

FIG. 10 is a sectional view of FIG. 9.

FIG. 11 is a view showing a mounting process of the chemical supplier according to the embodiment of the present disclosure.

### DETAILED DESCRIPTION

The above and other advantages and features of the present disclosure, and a method of achieving them will be more clearly understood with reference to the embodiment described below in detail in conjunction with the accompanying drawings. However, the present disclosure is not limited to the following embodiments, and can be embodied in various forms different from each other.

Hereinbelow, the technical features of the present disclosure will be described in detail with reference to the accompanying drawings.

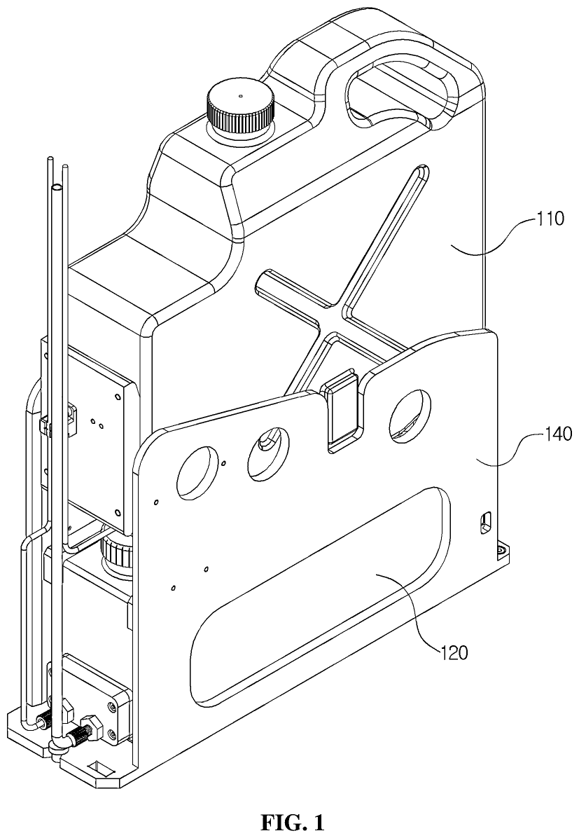

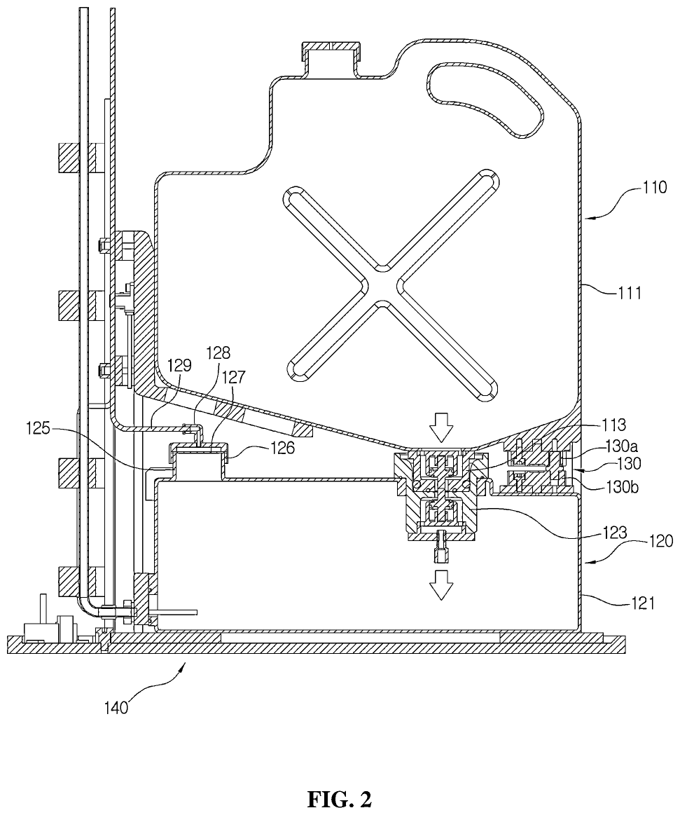

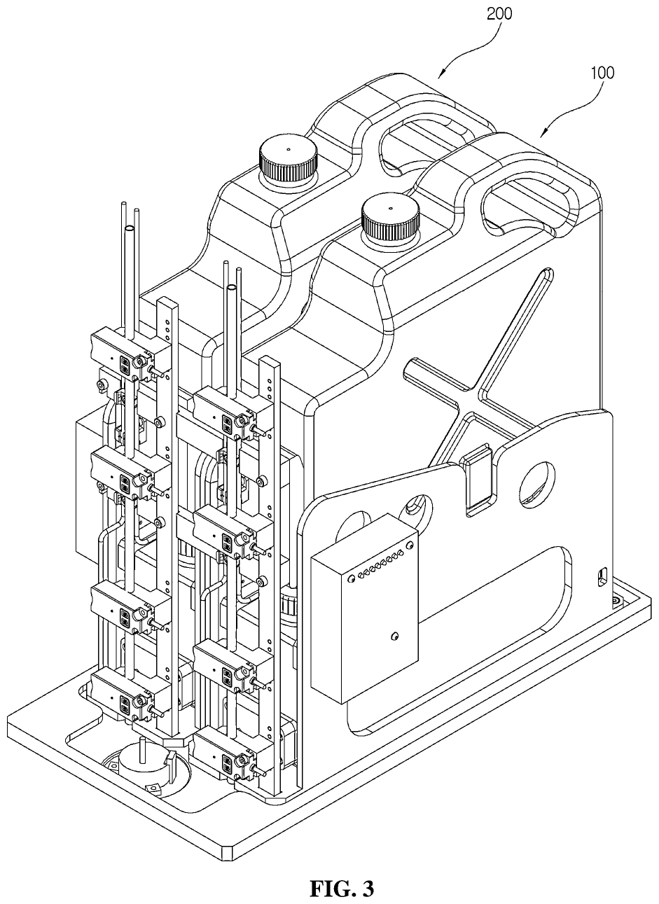

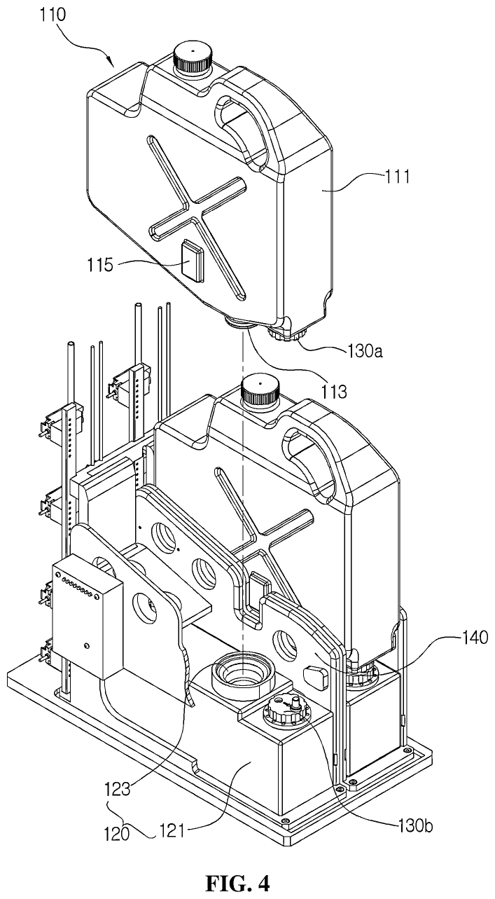

Referring to FIGS. 1 to 4, a chemical supplier according to the embodiment of the present disclosure may include a bottle 110, a reservoir 120, a joint assembly 130, and a guide casing 140.

As shown in FIG. 1, the chemical supplier of the present disclosure may have a singular configuration and be used to supply one type of chemical or may have a plurality of configurations. For example, the chemical supplier 100 may have a plurality of configurations divided into a first supply unit 101 and a second supply unit 103, and the first and second supply units 101 and 103 may be respectively installed at a base 105. When the chemical supplier 100 with multiple configurations has two or more configurations, the chemical supplier 100 may be used such that each supply unit 101, 103 supplies one type of chemical to increase the total capacity stored in the reservoir 120, or each supply unit 101, 103 receives different types of chemicals to supply various chemicals. Each of the supply units 101 and 103 may include the bottle, the reservoir, the joint assembly, and the guide casing.

According to the embodiment, the bottle 110 may be provided into a first container 111, and the first container 111 is configured to store a fluid to be supplied therein. At this point, the fluid to be supplied may mean a fluid such as a reagent, a chemical, or the like, and the certain amount of fluid is stored in the bottle 110. The bottle 110 has a discharge port 111a shaped into a hole open at a lower portion of the bottle, and the discharge port 111a may discharge the in-stored fluid outward. The discharge port 111a has a discharge adapter 113 and the discharge adapter 113 facilitates fluid supply. This operation will be described below.

According to the embodiment, the reservoir 120 may be provided into a second container 121, and the second container 121 is configured to store the certain amount of a fluid. The reservoir 120 may be arranged at the lower portion of the bottle 110 and be connected to the bottle 110. Accordingly, the reservoir 120 may receive the fluid stored in the bottle 110. To this end, the reservoir 120 may have an inlet 121a, which is fluidically connected to the discharge port 111a, at an upper portion of the second container 121, and may receive the fluid to be supplied through the inlet.

At this point, the inlet 121a may be shaped into a hole that is open on the reservoir 120 to be directly or indirectly connected to the discharge port 111a. An inlet adapter 123 combinable to the discharge adapter 113 is installed at the inlet 121a to facilitate fluid supply. Therefore, the fluid stored inside the bottle 110 is lowered by gravity to be introduced into the reservoir 120.

The connection structure of the discharge adapter 113 and the inlet adapter 123 to directly transfer a fluid between the bottle 110 and the reservoir 120 may be provided into a valve of an opening and closing type.

For example, the adapters may be provided into a coupling structure of a socket and a plug. The discharge adapter 113 may have a form of a connecting plug, and the inlet adapter 123 may have a form of a connecting socket into which the discharge adapter 113 is inserted.

The discharge adapter 113 includes a first housing 113a, a first moving member 113b, and a first body 113c, and has a flow path in the body, which is communicatable with the inlet adapter, while the first moving member 113b is brought into contact with a moving member of the inlet adapter 123.

Like the discharge adapter 113, the inlet adapter 123 includes a second housing 123a, the second moving member 123b, and the second body 123c, and has a flow path therein through which the fluid flows while the second moving member 123b is moved. In other words, channels forming respective flow paths are opened and closed by the movement of the moving member.

With the valve-type coupling structure of the adapters, the fluid in the bottle 110 may be moved into the reservoir 120.

In addition, the reservoir 120 has an outlet 122 at one side of the second container 121 to supply the fluid to be supplied to an outside part. At this point, the outside part may mean facilities supplied with a fluid by the chemical supplier of the present disclosure. At least one connecting tube may be connected to the outlet 122. In other words, the reservoir 120 may discharge the fluid through the outlet 122 connected to the outside part to a device or a line where the fluid will be used.

Furthermore, the reservoir 120 may include a reservoir cap 126 serving as an air vent at an upper portion thereof, and the reservoir cap 126 is configured to control a flow of the fluid smooth with the function of air vent. For example, the reservoir cap 126 may be coupled to an air vent port 125 formed by protruding on the upper portion of the reservoir 120. An air vent cap 127 may be installed between the air vent port 125 and the reservoir cap 126 to allow a passage of air and to prevent the fluid from being discharged outward. In addition, an air vent fitting member 128 is installed at the air vent cap 127, and a vent tube 129 is connected to one end of the air vent fitting member 128 to allow a supply toward a vent line. The air vent structure may prevent overflow even if the fluid is stored in the reservoir 120 over a certain amount, and may allow passage of air to maintain the difference in air pressure in the reservoir 120 to guide the flowability of the fluid introduced into the reservoir 120 smoothly.

At this point, since the bottle 110 and the reservoir 120 of the present disclosure are arranged at an upper portion and a lower portion with the guide casing 140, which will be described below, fluid transfer in a vertical direction may be performed.

In the configuration, as the reservoir 120 is located at the lower portion and the bottle 110 connected to the reservoir 120 is located at the upper portion, the fluid may be naturally moved by gravity from the bottle 110 to the reservoir 120. Since the discharge port 111a is installed at the lower portion of the bottle 110, all fluid may be substantially transferred to the reservoir 120 without the remaining amount of the fluid, and since the reservoir 120 may receive the certain amount of the fluid, even when the bottle 110 is separated from the reservoir 120 in an empty state, the fluid in the reservoir 120 may be continuously supplied to a desired place for a predetermined period through a discharge tube connected to the outlet 122.

According to the embodiment, the joint assembly 130 is installed between the bottle 110 and the reservoir 120 and may provide a mutual cognition structure that controls the physical coupling between the bottle 110 and the reservoir 120.

At this point, according to the embodiment, since the chemical supplier has the structure such that the bottle 110 and the reservoir 120 are arranged at the upper portion and the lower portion and the discharge port 111a and the inlet 121a are directly coupled to each other in the vertical direction without using a separate line-type connection tube, it is limited in preventing the operator from accidentally connecting the bottle with a different type of fluid to the reservoir. Accordingly, the joint assembly 130 of the present disclosure is configured to control the physical coupling between the bottle and the reservoir by the mutual cognition structure.

In other words, as the chemical supplier of the present disclosure uses the joint assembly 130 to allow the physical coupling only for the same fluid and prevent the physical coupling for different types of fluids, the bottle with a different type of fluid is prevented from being coupled to the reservoir, thus minimizing mixing accidents according to mis-coupling.

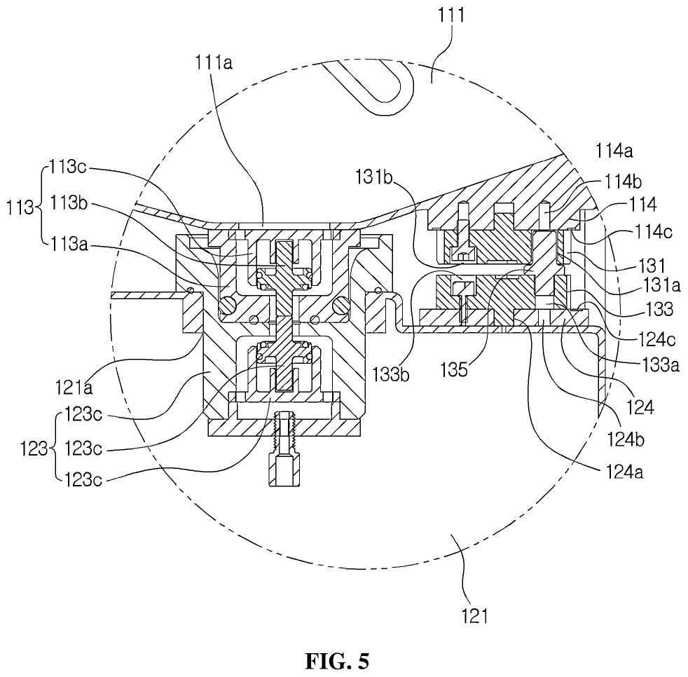

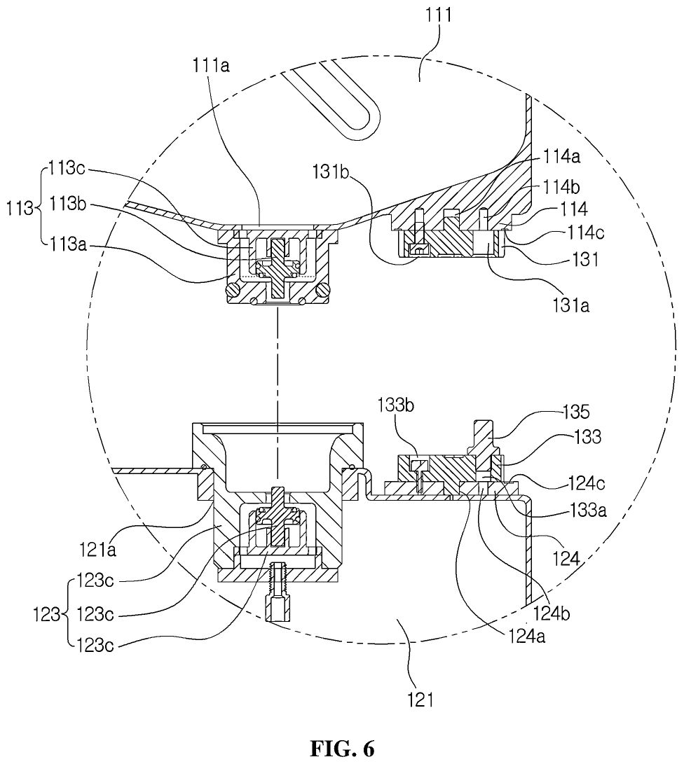

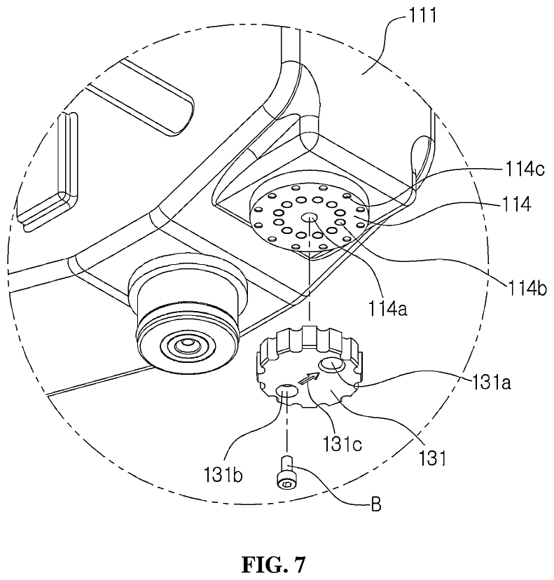

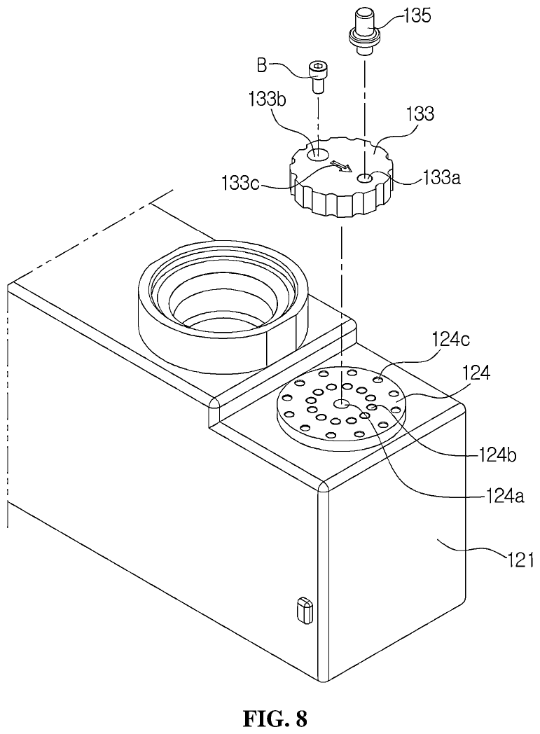

In addition, according to the embodiment, the joint assembly 130 may include a first cognition unit 130a provided at the bottle 110 and a second cognition unit 130b provided at the reservoir 120. A structure of the joint assembly 130 will be described in detail from FIGS. 5 to 8.

The first cognition unit 130a located at the bottle 110 may be provided at the lower portion of the first container 111 and may be arranged at a position spaced apart from the discharge port 111a. A cognition coupling groove 131a having a hole shape is formed in the first cognition unit 130a.

The cognition coupling groove 131a may be formed to have a location preset according to a type of fluid to be supplied, stored in the bottle 110. In other words, the cognition coupling groove 131a is configured to be selectively changeable into different locations according to types of fluids, and preset location information may be included in a manufacturing process of the bottle 110 where the fluid to be supplied is stored or may be preset when a fluid is supplied to the equipment where the fluid will be used. In other words, the cognition coupling groove 131a is configured such that a selected location thereof is fixed as the fluid to be supplied is provided in the bottle 110 while being stored therein.

To this end, the first cognition unit 130a may include a first dial 131 in which the cognition coupling groove 131a is formed, and a first body 114 formed in the first container 111 as a portion to which the first dial 131 is coupled.

The first dial 131 may be shaped roughly in a disc form, and a shaft (not shown) having a protrusion shape is formed at a center portion thereof, so that the first dial 131 may be provided to be rotatable concentrically to the first body 114. The first dial 131 changes the location of the cognition coupling groove 131a while being rotated. At this point, the first dial 131 may be securely installed at the first body 114 in a pin-coupling manner or a screw-coupling manner. As shown in the drawing, the first dial 131 includes a first pin coupling groove 131b formed in a location opposite to the cognition coupling groove 131a. A first fixation member B provided in a form of an inserting-type pin or screw is inserted into the first pin coupling groove 131b to pass therethrough, and the first fixation member B is coupled to the first body 114 to fix the first dial 131.

The first body 114 may be integrally formed with the lower portion of the first container 111, a center portion of the first body 114 has a first shaft groove 114a to which the shaft of the first dial 131 is coupled, and multiple first fastening grooves 114b for the first fixation member B installed at the first dial 131 to be coupled thereto are formed in a circular arrangement around the center portion of the first body 114.

As described above, as the first dial 131 is installed to be rotatable to the first body 114, the first cognition unit 130a may adjust the location of the cognition coupling groove 131a according to a type of fluid to be supplied. In other words, the cognition coupling groove 131a may have the preset location that may be changed according to a type of fluid to be supplied, stored in the container. However, the location of the cognition coupling groove 131a may only be provided in a fixed state at the preset location when a fluid stored in the bottle 110 is determined and may have the location-changeable structure for the initial setting.

Meanwhile, the second cognition unit 130b located at the reservoir 120 may be provided at the upper portion of the second container 121. The second cognition unit 130b may be arranged at a location spaced apart from the inlet 121a, and may include a cognition coupling key 135 protruding to be inserted into the cognition coupling groove 131a.

The cognition coupling key 135 may have a location-changeable structure to correspond to the set location of the cognition coupling groove 131a of the first cognition unit 130a. In other words, the cognition coupling key 135 is configured to be selectively changed into a different location according to a type of fluid to be supplied, which is supplied from the bottle 110.

To this end, the second cognition unit 130b may include a second dial 133 in which the cognition coupling key 135 is installed and a second body 124 formed on the second container 121 and coupled to the second dial 133. Except that the second body 124 is formed integrally with the reservoir 120, the second cognition unit 130b may be formed similarly to the overall structure of the first cognition unit 130a.

The second dial 133 may be a disc-shaped member having the form corresponding to the first dial 131 and may be installed to be rotatable to the second body 124 with a shaft protruding on a center portion thereof. The second dial 133 may change the installation location of the cognition coupling key 135 by rotation. The second dial 133 has a key groove 133a in which the cognition coupling key 135 is installed, and a second pin coupling groove 135b formed at a location opposite to the key groove 133a and allowing a second fixation member B to be inserted through the second pin coupling groove. Therefore, the second dial 133 may be securely installed at the second body 124 through the second fixation member B.

The second body 124 may be integrally formed with a lower portion of the second container 121, and has a second shaft groove 124a formed in the center portion thereof, the shaft of the second dial 133 is coupled thereto, and multiple second fastening grooves 124a formed in a circular arrangement around the second shaft groove 124a.

Accordingly, the second cognition unit 130b has a structure that can change the location of the cognition coupling key 135 to a location corresponding to the cognition coupling groove 131a while the second dial 133 is rotated against the second body 124, thereby setting the location of the cognition coupling key 135 to the preset location according to a used fluid. Accordingly, the second cognition unit 130b allows coupling between the bottle 110 and the reservoir 120 as the cognition coupling key 135 is inserted into the cognition coupling groove 131a.

On the other hand, since a bottle storing a different fluid other than the fluid used in the chemical supplier of the embodiment has a different set location, the joint assembly 130 of the mutual cognition structure restricts the physical coupling by different locations of the first cognition unit 130a and the second cognition unit 130b to prevent the mis-coupling, thus preventing a supply of a different fluid in advance.

As described above, the joint assembly 130 of the embodiment has the configuration including the first dial 131 installed at the bottle 110 and the second dial 133 installed at the reservoir 120, and may restrict the physical coupling between the bottle 110 and the reservoir 120 with the responding structure of the cognition coupling groove 131a and the cognition coupling key 135 provided in the respective dials.

In other words, the joint assembly 130 is configured to normally connect the bottle 110 to the reservoir 120 according to whether or not the location of the cognition coupling groove 131a and the location of the cognition coupling key 135 match. Therefore, when the location of the cognition coupling groove 131a and the location of the cognition coupling key 135 do not match, the physical coupling between the bottle 110 and the reservoir 120 can be prevented.

Therefore, the chemical supplier of the present disclosure is configured to restrict the physical coupling between the bottle and the reservoir to prevent coupling between the bottle 110 and the reservoir 120 as the key coupling locations of the joint assembly 130 preset in the bottle 110 and the reservoir 120 are differently provided when different types of fluids provided for injection is supplied, and to couple the bottle 110 to the reservoir 120 as the key coupling locations of the joint assembly 130 are provided to correspond to each other only when types of the fluids match.

Therefore, according to the embodiment of the present disclosure, the chemical supplier can prevent the mis-injection of a fluid in advance by restricting the physical coupling by the joint assembly 130 for the bottle 110 storing a fluid different from a fluid that should be injected into the reservoir 120 installed in the guide casing 140.

Meanwhile, the joint assembly 130 of the present disclosure may have a code display part 114c, 124c for cognition formed at each body or dial, and the code display part 114c, 124c is formed at a location corresponding to each key code which means a code for each reagent. For example, the code display part 114c, 124c may be displayed with a code having a form of colors or symbols (letters or numbers) at a portion adjacent to each hole which is the installation location of the cognition coupling groove 131a and the cognition coupling key 135. For example, the code display part 114 may be displayed by attaching a colored sticker representing each key code or in a method of carving letters or numbers. Referring to the drawings, it is shown that, on surfaces of the first body 114 and the second body 124, the key codes are respectively marked at locations spaced concentrically outward from the circular arrangements of the cognition coupling groove 131a and the cognition coupling key 135. Accordingly, the code display part 114c, 124c is configured such that a matching or mismatching state of the colors or symbols is visible to the naked eye thus facilitating the cognition of each key code before the physical coupling so that a type of reagent can be easily identified.

Moreover, the joint assembly 130 may include a location display part 131c, 133c. The location display part 131c, 133c is marked with an arrow sign indicating the location of the cognition coupling groove 131a and the location of the cognition coupling key 135 to increase degree of understanding when identifying the corresponding key code in the naked eye.

According to the embodiment, the guide casing 140 stores the bottle 110 and the reservoir 120 in a removable manner, and functions to support the bottle 110 and the reservoir 120 connected by the joint assembly 130 in the connected state.

The guide casing 140 may include a casing main body unit 140, a first mounting unit 140a, and a second mounting unit 140b.

The casing main body unit 140 provides a frame structure which is provided to stably support the bottle 110 and the reservoir 120.

The first mounting unit 140a is formed at an upper portion of the casing main body unit 140 to be open and divides the installation space of the bottle 110.

The second mounting unit 140b may be formed in a lower portion of the casing main body unit 140 and divides the installation space of the reservoir 120 as a second portion is formed to be open. The second mounting unit 140b is arranged to be spaced below from a lower portion of the first mounting unit 140a, thus allowing the bottle 110 and the reservoir 120 to be maintained in a vertical coupling structure (up & down coupling method).

The guide casing 140 keeps the bottle 110 and the reservoir 120 respectively stored in the mounting units 140a and 140b at a constant interval.

A detail configuration of the guide casing 140 will be described below.

The chemical supplier 100 of the present disclosure configured as described above may allow a reagent of the bottle 110 to flow into the reservoir 120 as the bottle 110 and the reservoir 120 are held in the guide casing 140 and connected to each other in a mutually communicative manner.

As described above, as the bottle 110 is located at the upper side and the reservoir 120 connected to the bottle 110 is located at the lower side, the chemical supplier 100 according to the embodiment of the present disclosure may move the fluid therein from the upper side to the lower side by gravity.

At this point, the chemical supplier 100 of the present disclosure has the discharge port 111a provided at the lower portion of the bottle 110, so that the fluid stored in the bottle 110 is transferred to the reservoir 120 without a residual, and since the reservoir 120 stores the certain amount of fluid, even when the bottle 110 is empty and the bottle 110 is separated from the reservoir 120 and the guide casing 140, the fluid can be continuous supplied to a place where the fluid is needed, by the remaining fluid stored in the reservoir 120, which is the advantage.

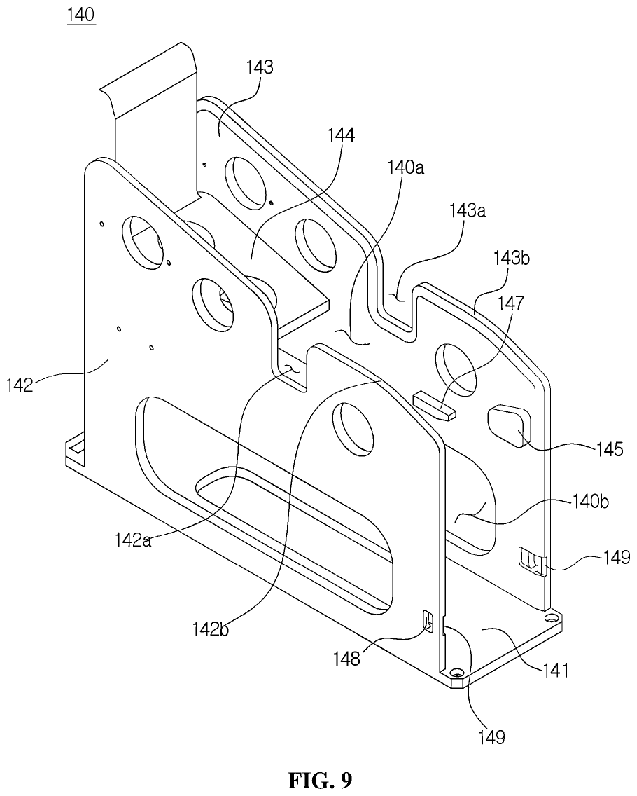

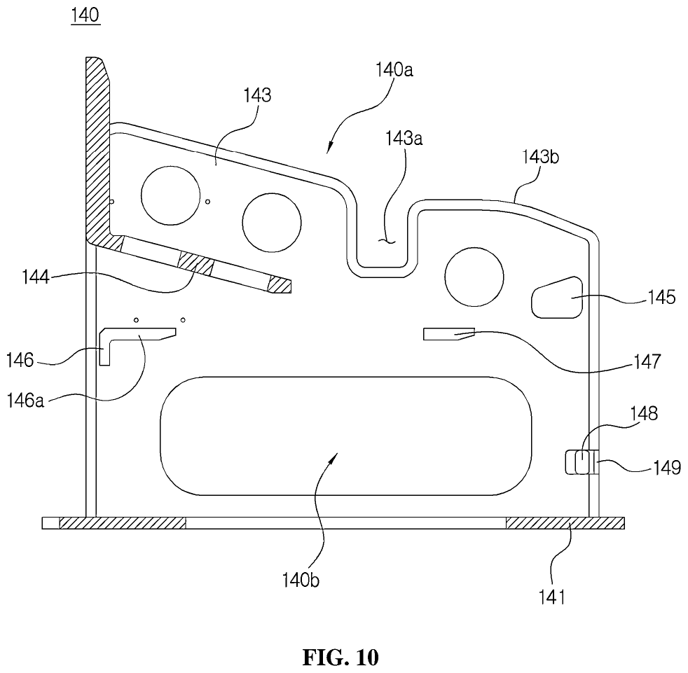

FIGS. 9 and 10 are a perspective view and a sectional view schematically showing the guide casing 140 according to the embodiment of the present disclosure. The configuration of the guide casing 140 will be described in detail from FIGS. 9 and 10.

According to the embodiment, the casing main body unit 140 includes a base plate 141 installed at the bottom, and a plurality of vertical plates 142 and 143 provided upright to face each other at opposite portions of the base plate 141.

The base plate 141 may be formed into roughly a rectangular plate having a length extending toward a first side and a second side, and the reservoir 120 is seated on an upper surface of the base plate 141.

The plurality of vertical plates 142 and 143 is installed at the opposite portions in the width direction crossing the length direction of the base plate 141 to restrict transverse movements of the bottle 110 and the reservoir 120.

At this point, the casing main body unit 140 according to the embodiment includes a support plate 144 to support a lower surface of the bottle 110, and the support plate 144 is arranged to cross between the vertical plates 142 and 143 at a first side of the vertical plates 142 and 143.

The support plate 144 may be formed into a plate-shaped member and be installed to correspond to one portion of a lower surface of the first container 111 to stably support the first container 111.

Furthermore, the casing main body unit 140 according to the embodiment includes auxiliary support pieces 145, and the auxiliary support pieces 145 are formed at a second side of the vertical plates 142 and 143 by protruding on locations spaced apart from the support plate 144 and support the lower surface of the bottle 110.

The auxiliary support pieces 145 are installed at the locations opposite to the support plate 144 to correspond to a second portion of the lower surface of the first container 111 and stably support the first container 111 together with the support plate 144.

At this point, it is characterized in that the support plate 144 and the auxiliary support pieces 145 have respective upper surfaces formed to be inclined downward in facing directions. In other words, the support plate 144 and the auxiliary support pieces 145 may be arranged to be inclined downward toward the discharge port 111a formed in the lower portion of the bottle 110.

In addition, these inclined structures relate to a figural characteristic of the bottle 110, and the bottle 110 according to the embodiment has a form that the opposite portions of the lower portion of the first container 111 are inclined downward toward the discharge port 111a, as shown in the drawing. Accordingly, the bottle 110 may function to discharge the overall amount of the fluid to be supplied, which is stored therein.

With this form of the bottle 110, the support plate 144 and the auxiliary support pieces 145 of the embodiment have the inclined structure to correspond to the lower form of the bottle 110.

Accordingly, the support plate 144 and the auxiliary support pieces 145 are formed to correspond to the form of the bottle 110 to firmly support the bottle 110, and to secure stable bearing capacity for the bottle 110 due to the V-shaped arrangement structure.

Furthermore, the bottle 110 according to the embodiment may include a protruding block 115.

The protruding block 115 may be provided by protruding on at least one side surface of the first container 111 which is supported by the vertical plates 142 and 143. For example, the protruding block 115 is formed by protruding into a quadrangle form on the opposite surfaces of the first container 111.

At this point, corresponding to the protruding block 115, the vertical plates 142 and 143 include inserting slots 142a and 143a of which upper portions are formed open to allow insertion of the protruding block 115.

The inserting slots 142a and 143a may be formed into depressed grooves having a form corresponding to the form of the protruding block 115 to allow insertion of the protruding block 115. In other words, the inserting slots 142a and 143a are formed to be depressed on locations corresponding to the protruding block 115, at the upper portions of the vertical plates 142 and 143.

When the bottle 110 is coupled to the guide casing 140, the inserting slots 142a and 143a may maintain the stable coupling state as the protruding block 115 is inserted thereinto. Specifically, the protruding block 115 and the inserting slots 142a and 143a have the structure supporting at least 3 surfaces thereof due to the quadrangle form, so that movements in the first and second directions and excessive downward movement of the bottle 110 can be limited. As described above, the present disclosure can provide a stable coupling structure.

Moreover, according to the embodiment, the vertical plates 142 and 143 may include sliding guide surfaces 142b and 143b. The sliding guide surfaces 142b and 143b are provided as guiding surfaces on which the protruding block 115 provided on the bottle 110 is movable to the locations of the inserting slots 142a and 143a while being seated on upper portions adjacent to second ends. Therefore, the vertical plates 142 and 143 may have a form in which an upper portion has a predetermined curvature path.

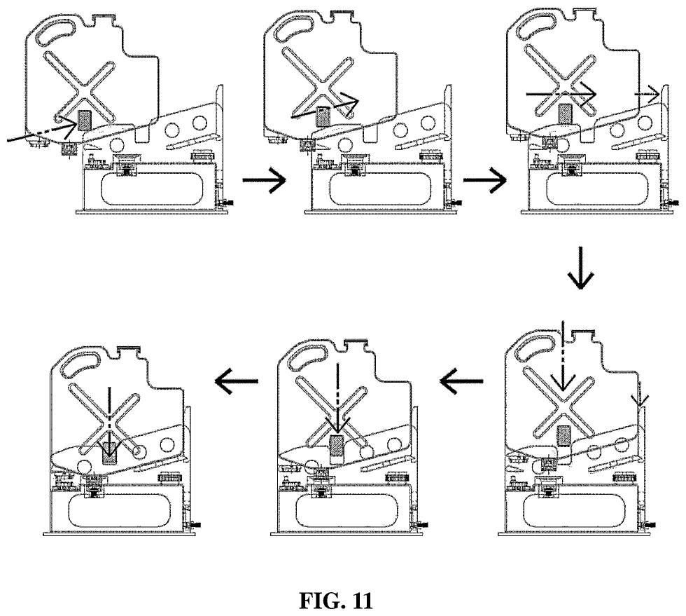

As shown in FIG. 11, the sliding guide surfaces 142b and 143b may serve as a guide during the work of coupling the bottle 110 to the reservoir 120, so that convenience in use with the coupling structure using the protruding block 115 can be secured.

furthermore, according to the embodiment, the casing main body unit 140 includes stoppers 146, and the stoppers 146 protrude on the inner surfaces of the vertical plates 142 and 143 to prevent the reservoir 120, which is inserted from a second side of the second mounting unit 140b, from being removed toward a first side.

The stoppers 146 are formed into block-shaped protrusions on the inner surfaces of the vertical plates 142 and 143 to restrict movement in the first direction of the second container 121.

At this point, the vertical plates 142 and 143 respectively include insertion holes 148 at locations opposite to the stoppers 146 to allow coupling protrusions 121b formed by protruding on the second ends of the second container 121 to be coupled to the insertion holes 148, and guiding grooves 149 formed by extending to guide entering of the coupling protrusions 121b toward the insertion holes 148. Accordingly, a stable fixed state of the reservoir 120 can be maintained.

Meanwhile, according to the embodiment, the casing main body unit 140 includes first pushing pieces 147 on the inner surfaces of the vertical plates 142 and 143 and at locations spaced apart from the stoppers 146 to support the upper surface of the reservoir 120.

The first pushing pieces 147 are disposed to be spaced apart from the base plate 141 at a predetermined height and a height-directional interval therebetween is limited within a predetermined distance, so that a space having a form in which the second container 121 is pressed by the first pushing pieces 147 is provided when the second container 121 is slidingly inserted into the second mounting unit 140b. In other words, the first pushing pieces 147 may allow the second container 121 to be mounted into the guide casing 140 in an inserting manner, thus being stably supported by the guide casing 140.

At this point, the casing main body unit 140 includes second pushing pieces 146a formed by extending horizontally from the stoppers 146 to support the upper surface of the reservoir 120. The second pushing pieces 146a are arranged to be spaced apart from the first pushing pieces 147 to stably support the reservoir 120.

As described above, the guide casing 140 may hold the bottle 110 and the reservoir 120 with a spacing therebetween.

As described above, according to the embodiment of the present disclosure, the chemical supplier 100 may provide the structure, which limits or allows the physical coupling by the joint assembly 130 providing the mutual cognition structure, so that mis-injection of a fluid due to accidental coupling can be prevented in advance.

In addition, according to the embodiment of the present disclosure, the chemical supplier may be configured such that the bottle 110 is simply mounted and separated by the guide casing 140.

Specifically, the chemical supplier of the present disclosure has a docking structure by which the bottle is vertically coupled thereto, so that the stable coupling state between the bottle 110 and the reservoir 120 can be maintained.

Furthermore, the chemical supplier of the present disclosure may provide stable fixation and pressure structure for a container by the guide casing 140, thus to facilitate transfer of a fluid.

Moreover, the chemical supplier of the present disclosure has the structure which can prevent bubbles from being generated during replacement work or filling work, thus improving data stability.

To this end, a tube (not shown) having a pipe line of I-shape or L-shape is connected to the inlet adapter 123, so that a fluid may be discharged at a lower portion of the reservoir 120. In other words, the tube may minimize bubble generation caused by fluid dropping from the inlet adapter 123.

At this point, the tube is formed into a pipe line of L-shape, and the tube discharges a fluid at a side surface opposite to the outlet to minimize bubbles discharged through the outlet even when the bubbles are generated.

Furthermore, the chemical supplier of the present disclosure may detect the remaining amount by a sensor to cognize a replacement time, thereby preventing the supply of a reagent from being blocked due to lack of a reagent.

To this end, the chemical supplier according to the embodiment may be preferably configured such that a plurality of sensors (not shown) is attached thereto and controlled by a monitoring system (not shown) connected to the external part. The plurality of sensors may include a level detecting sensor for measuring a level of a reagent, a bubble detecting sensor for detecting generation of bubbles, a leakage detecting sensor for detecting a portion where a leakage occurs, etc.

Furthermore, according to the embodiment of the present disclosure, the chemical supplier 100 may be configured such that the bottle 110 is easily connected to the reservoir 120 by the adapter with the valve structure, and may prevent a chemical from being arbitrarily discharged through the valve structure, so that a problem of leakage of a chemical in replacement can be minimized.

The above description is only illustrative of the technical idea of the present disclosure, and those skilled in the art will appreciate that various modifications are possible without departing from the scope of the technical idea of the present disclosure. Therefore, the exemplary embodiment of the present disclosure has not been described for limiting purposes, and the technical scope of the present disclosure is not to be limited by the foregoing embodiment.

1. A chemical supplier comprising:
a bottle storing a fluid to be supplied therein and comprising a discharge port formed at a lower portion thereof;
a reservoir comprising an inlet formed at an upper portion thereof, the inlet being fluidically connected to the discharge port, to receive the fluid to be supplied, which comprising an outlet formed at one portion thereof to supply the fluid to be supplied outward;
a joint assembly of a mutual cognition structure, which is provided between the bottle and the reservoir to control physical coupling between the bottle and the reservoir; and
a guide casing storing the bottle in a removable manner and supporting the bottle and the reservoir connected to each other by the joint assembly in a connected state.

2. The chemical supplier of claim 1, wherein the guide casing comprises:
a casing main body unit in which the bottle and the reservoir are provided;
a first mounting unit formed at an upper portion of the casing main body unit to be open to divide an installation space of the bottle; and
a second mounting unit formed at a second portion of the casing main body unit to be open and disposed to be spaced apart from a lower portion of the first mounting unit to divide an installation space of the reservoir.

3. The chemical supplier of claim 2, wherein the casing main body unit comprises:
a base plate provided at a bottom; and
a plurality of vertical plates provided upright to face each other at opposite portions of the base plate and restricting lateral movements of the bottle and the reservoir.

4. The chemical supplier of claim 3, wherein the casing main body unit further comprises a support plate disposed at a first side of the vertical plates to cross between the vertical plates to support a lower surface of the bottle.

5. The chemical supplier of claim 4, wherein the casing main body unit further comprises auxiliary support pieces formed by protruding on a second side of the vertical plates with intervals from the support plate and supporting the lower surface of the bottle.

6. The chemical supplier of claim 3, wherein the bottle comprises a protruding block protruding on at least one surface thereof, and
the vertical plates comprise inserting slots formed to be open upward such that the protruding block is insertable.

7. The chemical supplier of claim 6, wherein the vertical plates have paths of a predetermined curvature at upper portions thereof to provide sliding guide surfaces along which the protruding block provided on the bottle is movable to the position of the inserting slots while being seated on the upper portions.

8. The chemical supplier of claim 3, wherein the casing main body unit further comprises stoppers provided by protruding on inner surfaces of the vertical plates to prevent the reservoir inserted from the second side from being removed toward the first side.

9. The chemical supplier of claim 8, further comprising:
pushing pieces provided by protruding on positions of the inner surfaces of the vertical plates while being spaced apart from the stoppers to support an upper surface of the reservoir.

10. The chemical supplier of claim 1, wherein the joint assembly comprises:
a first cognition unit formed at the bottle and comprising a coupling groove fixed at a position selected according to a type of the fluid to be supplied; and
a second cognition unit formed at the reservoir and comprising a coupling key of which a position is changeable to correspond to the position of the coupling groove.
